(19) United States
(12) Patent Application Publication
(10) Pub. No.: US 2008/0152963 A1
(43) Pub. Date: Jun. 26, 2008

(54) Estimating fuel flow in a fuel cell system

(76) Inventors: Rebecca Dinan, Rochester, NY (US); Jing Ou, Latham, NY (US)

Correspondence Address: TROP PRUNER & HU, PC, 1616 S. VOSS ROAD, SUITE 750, HOUSTON, TX, 77057-2631, US

(21) Appl. No.: 11/645,137

(22) Filed: Dec. 22, 2006

(51) Int. Cl. H01M 8/04

(52) U.S. Cl. 429/13; 429/22

(57) ABSTRACT

Input parameters regarding operation of a fuel cell system are received, where the input parameters include, as examples, a setting of a valve, a setting of a blower, and a temperature in a reformer. The input parameters are applied to a model. Based on applying the input parameters to the model, an indication regarding source fuel flow in the fuel cell system is produced.

### BACKGROUND

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water.

A typical fuel cell has a terminal voltage near one volt DC. For purposes of producing larger voltages, several fuel cells may be assembled together to form an arrangement called a fuel cell stack, an arrangement in which the fuel cells are electrically coupled together in series to form a larger DC voltage and to provide more power.

The fuel provided to the anode input of the fuel cell stack can be hydrogen. One technique of producing hydrogen is to produce the hydrogen from hydrocarbons, such as natural gas, propane gas, or methanol. Typically, a reformer is used to convert hydrocarbons to hydrogen. The hydrocarbons that are provided to the reformer for the purpose of producing hydrogen are referred to as a “source fuel.”

It is desirable to know the flow rate of the source fuel to the reformer. Conventionally, a source fuel sensor is provided to monitor the flow of the source fuel. However, the source fuel sensor adds to the overall cost of the fuel cell system. Also, having to perform maintenance with respect to the source fuel sensor increases the maintenance complexity and overall maintenance cost associated with the fuel cell system.

### SUMMARY

In general, according to an embodiment, a method includes receiving input parameters regarding operation of a fuel cell system, and applying the input parameters to a model. Based on applying the input parameters to the model, an indication regarding source fuel flow in the fuel cell system is produced.

Other or alternative features will become apparent from the following description, from the drawings, and from the claims.

### BRIEF DESCRIPTION OF THE DRAWINGS

FIG. 1 is a block diagram of a fuel cell system that incorporates an embodiment of the invention.

FIG. 2 is a flow diagram of a process performed by a controller in the fuel cell system of FIG. 1, according to an embodiment.

### DETAILED DESCRIPTION

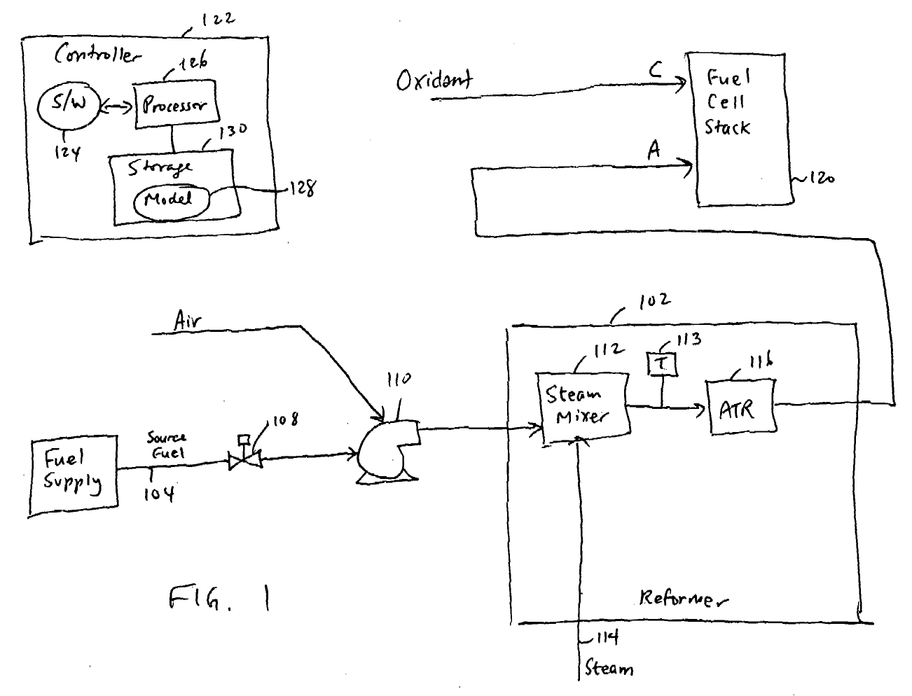

FIG. 1 shows a portion of an example fuel cell system according to an embodiment. The fuel cell system includes a reformer 102 for producing hydrogen from a source fuel 104 provided by a fuel supply 106 (e.g., a container of the source fuel 104 or a line providing the source fuel 104). An example of the source fuel 104 is propane gas. Other types of source fuels can be used, including natural gas, methanol, or other types of hydrocarbons. The source fuel 104 is provided through a stepper motor valve 108 to a fuel/air blower 110. The stepper motor valve 108 has multiple settings to fine tune the rate of fuel flow supplied through the fuel/air blower 110.

The stepper motor valve 108 has a stepper motor to step the valve 108 through the various possible positions of the valve 108. In other embodiments, other types of valves 108 having multiple settings (corresponding to different flow settings for the source fuel 104) can be used.

The fuel/air blower 110 also receives a flow of air (or other type of oxidant). The source fuel 104 and air is mixed by the fuel/air blower 110, with a mixture of the source fuel and the air produced at the output of the fuel/air blower 110 to the reformer 102. The fuel/air blower 110 also has various settings, including a fully off position, a fully on position, and one or more incremental positions corresponding to different speeds of the fuel/air blower 110.

The reformer 102 has many components, including a steam mixer 112 that receives at one input the mixture of the source fuel and air provided by the fuel/air blower 110. The steam mixer 112 has another input to receive steam 114. The steam 114 is mixed with the air and source fuel 104 in a chamber of the steam mixer 112.

A mixture of the steam, air, and source fuel is provided to an ATR (auto-thermal reformer) 116 for further processing. Other components are also part of the reformer, but are not depicted in FIG. 1. The processing performed by the components of the reformer 102 causes the input source fuel 104 to be converted to hydrogen-rich stream (which is the fuel provided to a fuel cell stack 120 in the fuel cell system).

At its input (anode inlet), the fuel cell stack 120 receives the fuel provided by the reformer 102. At its other input (cathode inlet), the fuel cell stack 120 receives an oxidant (e.g., air). Reactions are performed in the fuel cell stack 120 with respect to the hydrogen and the oxidant received at the anode and cathode inlets, respectively, of the fuel cell stack 120. From the reactions, electrical power is provided by the fuel cell stack 120.

FIG. 1 also shows a controller 122 associated with the fuel cell system, where the controller 122 controls various aspects of the fuel cell system. In accordance with some embodiments, the controller 122 is also able to estimate the flow rate (or other parameter) of the source fuel 104. The controller 122 includes software 124 that is executable on a processor 126, which can be formed from one or more microprocessors, microcontrollers, computers, or a combination of these components.

In accordance with some embodiments, a model 128 is stored in a storage 130 in the controller 122. The model 128 is used by the software 124 to perform estimation of the source fuel flow rate, without the use of a source fuel sensor. The software 124 receives various input parameters regarding operation of the fuel cell system, and in particular, regarding operation of the stepper motor valve 108, the fuel/air blower 110, and the steam mixer 112. The received input parameters are applied to the model 128, from which an estimated source fuel flow rate can be derived. Thus, the input parameters that are received by the software 124 include a setting of the valve 108, a setting of the fuel/air blower 110 (or alternatively, the pressure across the fuel/air blower 110), and a temperature at the output of the steam mixer 112, which can be measured with a temperature sensor 113. The temperature at the output of the steam mixer 112 is indicative of the ratio between the steam flow and the hydrocarbon flow. The steam/hydrocarbon ratio affects the pressure drop from the outlet of the fuel/air blower 110 to the exhaust of the entire fuel cell system (atmosphere), which affects the source fuel flow.

In some embodiments, the model 128 used by the software 124 for the purpose of estimating source fuel flow is an artificial neural network (ANN). An ANN is made up of a network of processors referred to as neurons that carry out simple calculation. In one type of structure of the ANN, the neurons are arranged in layers, where inputs are processed and propagated from input layer to the output layer. The signals that each neuron receives are weighted. These weights are determined using a learning algorithm, with one such learning algorithm referred to as a “back-propagation learning algorithm.”

Learning of the neural network can be performed either offline or online. Offline learning of the neural network refers to learning the neural network independent of the operation of the fuel cell system. In other words, the neural network is learned prior to deployment of the fuel cell system. This neural network is then loaded into the controller 122 of the fuel cell system as a static neural network.

On the other hand, online learning of the neural network refers to refining the neural network during operation of the fuel cell system. Online learning allows for continual refinement of the neural network resulting from operation of the fuel cell system. Online learning allows the neural network to be a dynamic neural network that changes over time to adapt to time-variant characteristics of the fuel cell system.

In other embodiments, instead of using a neural network as the model 128, other types of mathematical models can be used instead. These other types of models are coded or trained to recognize an input pattern (made up of predefined parameters of components of the fuel cell system) and to estimate a source fuel flow rate (or other parameter) based on the input pattern.

By being able to estimate source fuel flow rate without the use of a flow rate sensor, the overall cost of the fuel cell system can be decreased, since a hardware component (the flow rate sensor) can be omitted. Also, eliminating the flow rate sensor allows maintenance costs to be reduced, since maintenance does not have to be performed with respect to the flow rate sensor.

The arrangement of components depicted in FIG. 1 provides one example of a fuel cell system. In other embodiments, other arrangements can be implied. Also, although the stepper motor valve 108, fuel/air blower 110, and reformer 102 are depicted as being part of the fuel cell system, it is noted that the stepper motor valve 108, fuel/air blower 110, and reformer 102 can actually be a fuel source that is separate from the fuel cell system.

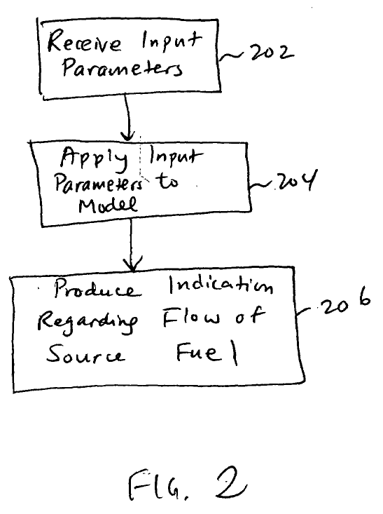

FIG. 2 shows a process performed by the software 124 in the controller 122, according to an embodiment. During operation of the fuel cell system, the software 124 receives (at 202) input parameters relating to operation of the fuel cell system, including the setting of the valve 108, the setting of the blower 110, and a temperature in the reformer 102. The input parameters are applied to the model 128 (e.g., neural network). Based on application of the input parameters to the model 128, the model 128 produces (at 206) an output indication regarding the flow of the source fuel 104, such as the source fuel flow rate.

The output indication regarding the flow of the source fuel 104 can be used by the controller 122 to perform various tasks. Also, the output indication regarding the flow of the source fuel 104 can be logged for later retrieval.

Instructions of software described above (including software 124 of FIG. 1) are loaded for execution on a processor (such as one or more processors 126 in FIG. 1). The processor includes microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
receiving input parameters regarding operation of a fuel cell system;
applying the input parameters to a model; and
producing, based on applying the input parameters to the model, an indication regarding source fuel flow in the fuel cell system.

2. The method of claim 1, wherein applying the input parameters to the model comprises applying the input parameters to a neural network, wherein the indication regarding source fuel flow is produced by the neural network.

3. The method of claim 2, further comprising performing learning of the neural network offline with respect to operation of the fuel cell system.

4. The method of claim 2, further comprising performing learning of the neural network during online operation of the fuel cell system.

5. The method of claim 1, wherein the fuel cell system comprises a controller to control components of the fuel cell system, and wherein applying the input parameters to the model and producing the indication regarding source fuel flow are performed by the controller.

6. The method of claim 1, wherein applying the input parameters to the model comprises applying at least some of a setting of a blower for the source fuel, a pressure across the blower, a setting of a valve through which the source fuel flows, and a temperature of a steam mixer that receives steam and a mixture of the source fuel and an oxidant.

7. The method of claim 1, wherein producing the indication regarding source fuel flow in the fuel cell system comprises producing the indication regarding the source fuel flow to a reformer in the fuel cell system.

8. The method of claim 1, wherein producing the indication regarding the source fuel flow comprises producing the indication regarding hydrocarbon flow.

9. The method of claim 1, wherein producing the indication regarding the source fuel flow comprises producing a source fuel flow rate.

10. A fuel cell system comprising:
a source fuel supply to provide a source fuel in the fuel cell system;
components to process the source fuel and an oxidant; and
a controller to:
receive parameters regarding operation of the components; and
compute, based on applying the received parameters to a model, an indication regarding a flow of the fuel.

11. The fuel cell system of claim 10, wherein the model comprises a neural network.

12. The fuel cell system of claim 10, wherein the components comprise a valve through which the source fuel flows, a blower to produce a flow of the source fuel, and a reformer.

13. The fuel cell system of claim 12, wherein the blower further receives an oxidant, and the flow of the source fuel produced by the blower is part of a flow of a mixture of the source fuel and the oxidant.

14. The fuel cell system of claim 13, wherein the reformer receives the flow of the mixture of the oxidant and the source fuel.

15. The fuel cell system of claim 14, wherein the reformer further comprises a steam mixer to mix the source fuel and oxidant with steam.

16. The fuel cell system of claim 15, wherein the received parameters that are applied to the model comprise a setting of the valve, a setting of the blower, and a temperature of the steam mixer.

17. The fuel cell system of claim 14, further comprising a fuel cell stack, wherein the reformer converts the source fuel to hydrogen that is provided to the fuel cell stack.

18. The fuel cell system of claim 10, wherein the computed indication comprises a computed source fuel flow rate.

19. An article comprising at least one storage medium containing instructions that when executed cause a controller to:
receive input parameters regarding operation of a fuel cell system;
apply the input parameters to a model; and
produce, based on applying the input parameters to the model, an indication regarding source fuel flow in the fuel cell system.

20. The article of claim 19, wherein applying the input parameters to the model comprises applying the input parameters to a neural network, wherein the indication regarding source fuel flow is produced by the neural network.

21. The article of claim 19, wherein applying the input parameters to the model comprises applying at least some of a setting of a blower for the source fuel, a pressure across the blower, a setting of a valve through which the source fuel flows, and a temperature of a steam mixer that receives steam and a mixture of the source fuel and an oxidant.
